(19) United States
(12) Patent Application Publication
(10) Pub. No.: US 2009/0158910 A1
(43) Pub. Date: Jun. 25, 2009

(54) SAW TOOTH

(76) Inventor: Mark Krehel, Kelowna (CA)

Correspondence Address: KENNAMETAL INC.;Intellectual Property Department, P.O. BOX 231, 1600 TECHNOLOGY WAY, LATROBE, PA, 15650, US

(21) Appl. No.: 12/353,285

(22) Filed: Jan. 14, 2009

Related U.S. Application Data
(63) Continuation of application No. 11/634,589, filed on Dec. 6, 2006.
Application No. 11/634,589 is a continuation-in-part of application No. 10/861,381, filed on Jun. 7, 2004, now Pat. No. 7,150,215.
(60) Provisional application No. 60/476,284, filed on Jun. 6, 2003.

(51) Int. Cl. B23D 61/06; B27B 33/12

(52) U.S. Cl. 83/839

(57) ABSTRACT

A replaceable cutter tooth for mounting to a saw blade has a concave front cutting surface extending from and between opposite kerf forming linear side edges, and from and between a radially inner curved edge, radially inner when mounted on a saw blade, and a radially outermost curved cutting edge. A groove extends in the radial direction from the radially inner curved edge to the radially outermost curved edge, generally medially between and substantially parallel to the side edges so as to reduce the surface area of a front face of the front cutting surface of the tooth for ease of re-sharpening in the field

### CROSS-REFERENCE TO RELATED APPLICATION

This application is a Continuation of U.S. patent application Ser. No. 11/634,589 filed Dec. 6, 2006, which is a Continuation-in-Part of U.S. patent application Ser. No. 10/861,381 filed Jun. 7, 2004, which claims priority from U.S. Provisional Patent Application No. 60/476,284 filed Jun. 6, 2003.

### FIELD OF THE INVENTION

The present invention relates to a replaceable carbide saw tooth, wherein the leading cutting face is arcuately concave and contains a medial, radially aligned recess.

### BACKGROUND OF THE INVENTION

Replaceable cutting teeth are commonly used on circular saws utilized in the wood or pulp manufacturing industry. Generally such teeth are preferably manufactured from a composite material having abrasion resistant properties such as tungsten carbide and are attached by braising or the like to the attack faces of a radial array of gullets formed about the periphery of a saw blank. Alternatively, such cutting teeth can be similarly attached to an elongated tooth holder or shank. A plurality of holder and cutting tooth assemblies may then be removably secured by bolting, pinning or other well known means within a radially aligned array of recesses formed about the periphery of a circular saw blank.

Such cutting tips when positioned on a circular saw blank have an upper cutting surface which extends radially outwardly of the periphery of the saw blank and extends generally parallel to the axis of saw rotation. Side cutting surfaces extend laterally outwardly of either the saw blank or the tooth holder or shank forming the kerf.

In the prior art of which applicant is aware U.S. Pat. No. 4,084,470 which issued Apr. 18, 1978 to Reed, discloses a cutting tooth secured to a holder or shank for insertion within a plurality of radially extending slots formed within the periphery of a flat steel disc.

The applicant is further aware of U.S. Pat. No. 4,765,217 which issued Aug. 23, 1988 to Ludwig, which discloses a cutting tip secured to a holder or shank. The teeth are formed so as to have a leading face which is generally “V” shaped or arcuately shaped in sectional view taken on a plane generally parallel to the axis of saw rotation.

### SUMMARY OF THE INVENTION

In the present invention a cutting tip has a generally arcuately concave leading face, when viewed in section, the face having a medial recess so as to reduce the contact surface area of the leading face of the cutter tip for ease of sharpening.

In summary, the replaceable cutter tooth for mounting to a saw blade according to the present invention includes a substantially concave front cutting surface extending from and between opposite kerf forming side edges, and from a radially inner curved edge, radially inner when mounted on the saw blade, to a radially outermost curved cutting edge. A groove extends in a radial direction, relative to the saw blade when the tooth is mounted thereon, from the radially inner curved edge to the radially outermost curved edge. The groove may be generally medially positioned between, and substantially parallel to, the side edges so as to reduce the surface area of a front face of the front cutting surface. The groove is recessed behind the front face relative to a direction of travel of the tooth when on the saw blade and the saw blade sawing a workpiece. The surface area is thereby reduced for ease of re-sharpening of the tooth.

The tooth may have a concave top surface, and the front cutting surface, a rear surface, a bottom surface and opposite side surfaces. A top cutting edge is formed at an intersection of the top surface and the front cutting surface. When viewed in side profile, the intersection of the top surface and the cutting surface forms an acute angle. The bottom surface and the front cutting surface may intersect generally at right angles, and the side surfaces may converge toward the bottom and rear surfaces.

In one embodiment the groove includes an oppositely disposed, laterally spaced apart pair of side groove surfaces defining a rear groove surface therebetween recessed behind the front face. The front face includes a pair of laterally therebetween recessed behind the front face. The front face includes a pair of laterally spaced apart faces on either side of the groove and elongate in the radial direction. The side groove surfaces and the rear groove surface define a channel. The rear groove surface may be planar or concave or otherwise non-planar.

In an alternative embodiment the groove is a first smoothly concave surface concave about the radial direction in which the groove extends. The groove may extend substantially the entire height of the front cutting surface of the tooth. In one embodiment the groove is formed only of the first smoothly concave surface. A first cross section across the first smoothly concave surface may form a first segment of a circle, wherein the first cross section is substantially orthogonal to the radial direction. A first radius corresponding to the first segment may be substantially constant for all such first cross sections along the groove.

For example, the first radius may be substantially 0.2 inches, and the acute angle formed between the concave top surface and the front surface may be substantially seventy degrees. The side surfaces may converge toward the bottom or rear surfaces by respective convergence angles. The convergence angles may be substantially between two and four degrees on each side of the tooth.

The concave top surface advantageously has a second smoothly concave surface. A second cross section across the second smoothly concave surface may form a second segment of a circle, wherein the second cross section is substantially parallel to the radial direction and substantially parallel to the front cutting surface. The top cutting edge is also formed of the second segment of a circle. In one embodiment the second segment of a circle at the top cutting edge has a second radius of substantially two thirds of an inch. The second segment of a circle has a corresponding second radius which is substantially constant for all of the second cross sections across the concave top surface. In one embodiment the second radius is substantially two thirds of an inch. Again, the acute angle may be substantially seventy degrees. The top cutting edge may have a width of substantially one half of an inch, and the front cutting surface may have a height of substantially one half of an inch.

### BRIEF DESCRIPTION OF THE DRAWINGS

FIG. 1 is a perspective view illustrating a prior art saw tooth.

FIG. 2 is a perspective view of the saw tooth of the present invention.

FIG. 3 is a plan view of the saw tooth.

FIG. 4 is a front elevation view of the tooth, viewed in the direction opposite to the direction of rotation of the saw.

FIG. 5 is a left hand side elevation view of the tooth.

FIG. 6 is a rear elevation view of the tooth.

FIG. 7 is a plan view of an alternative embodiment of the tooth in which bottom of the recess is arcuate.

FIG. 8 is a side view of an assembled tooth and holder.

FIG. 9 is a perspective view of the device illustrated in FIG. 8.

FIG. 10 is a perspective view of a portion of the tooth holder with the cutting tooth removed.

FIG. 11 is, in front perspective view, a further alternative embodiment of the saw tooth according to the present invention.

FIG. 12 is, in rear perspective view, the saw tooth of FIG. 11.

FIG. 13 is, in front elevation view, the saw tooth of FIG. 11.

FIG. 14 is, in rear elevation view, the saw tooth of FIG. 11.

FIG. 15 is, in plan view, the saw tooth of FIG. 11.

FIG. 16 is a sectional view along line 16-16 in FIG. 14.

### DESCRIPTION OF THE PREFERRED EMBODIMENTS

Saws used for example in sawmills or pulp manufacturing generally have replaceable cutting teeth which are either braised directly to a circular saw or braised to a tooth holder which is secured to the circular saw in one of several methods well known to the art.

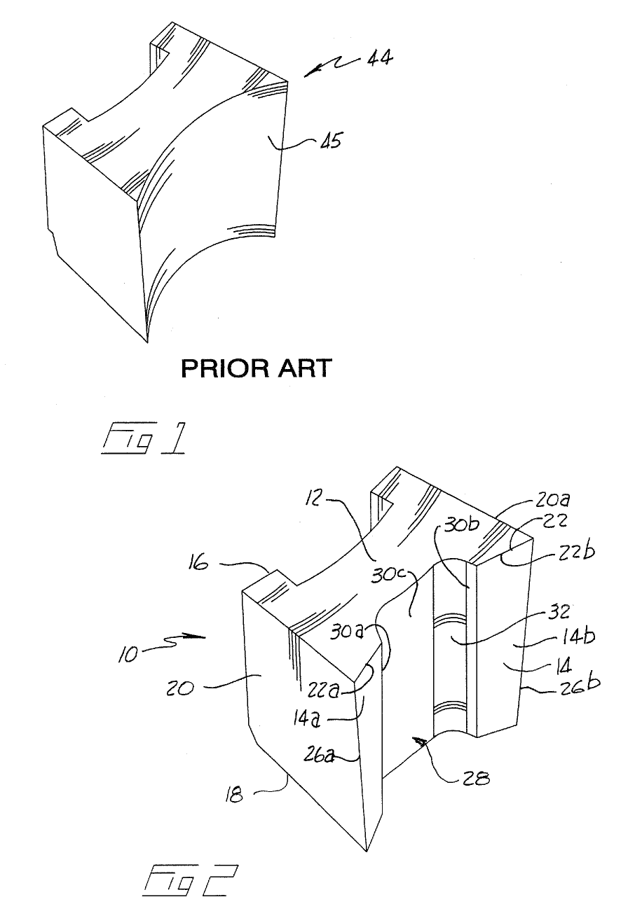

In the prior art saw tooth 44, illustrated in FIG. 1, the front face 45 presents a large continuous surface area. Consequently, re-sharpening this type of tooth presents an undue level of difficulty since the grinding wheel must be applied against face 45 with a large amount of pressure. Further, without a clearly defined groove or notch the flow of sawdust may not be efficiently channelled away from the cutting surface of the tooth.

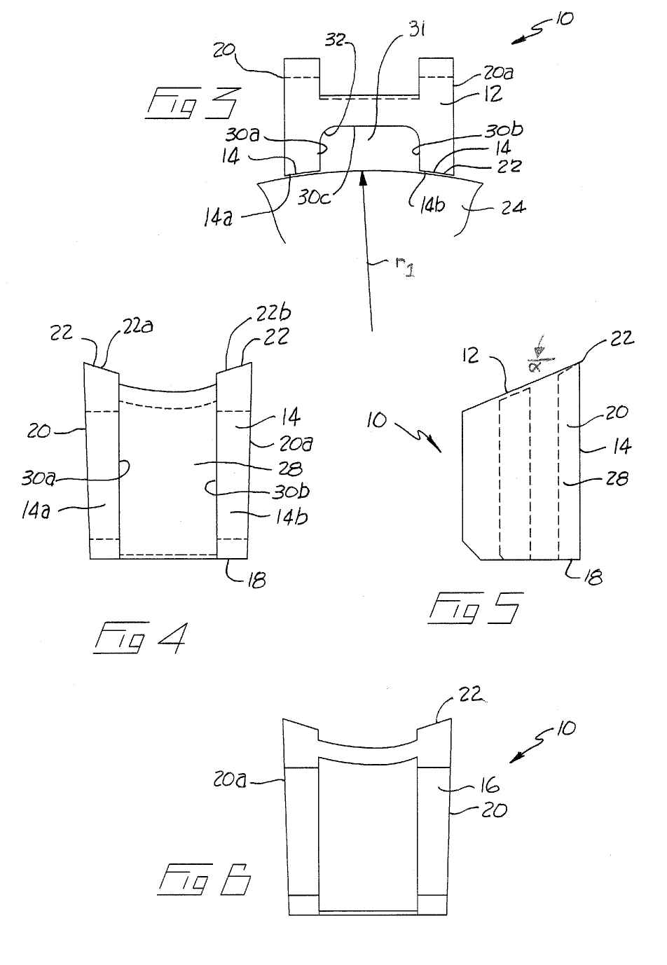

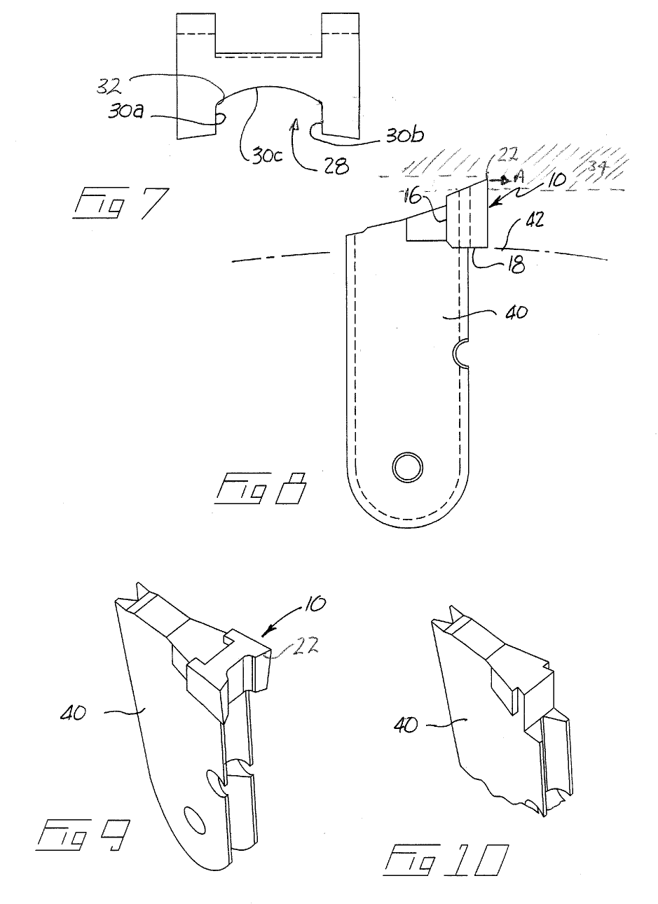

As can be seen in FIGS. 2 through 6, replaceable cutter tooth 10 has a concave top surface 12, a front surface 14, a rear surface 16, a bottom surface 18 and opposite side surfaces 20 and 20a respectively. A top cutting edge 22 is formed at the intersection of top surface 12, and front surface 14. When viewed in side profile, as illustrated in FIG. 5, the intersection of top surface 12 and front surface 14 forms an acute angle α as a result of surface 12 sloping rearwardly and slightly downwardly with respect to cutting edge 22. Bottom surface 18 and front surface 14 intersect generally at right angles. Side surfaces 20 and 20a converge slightly toward bottom surface 18, and may in alternative embodiments converge slightly toward rear surface 16.

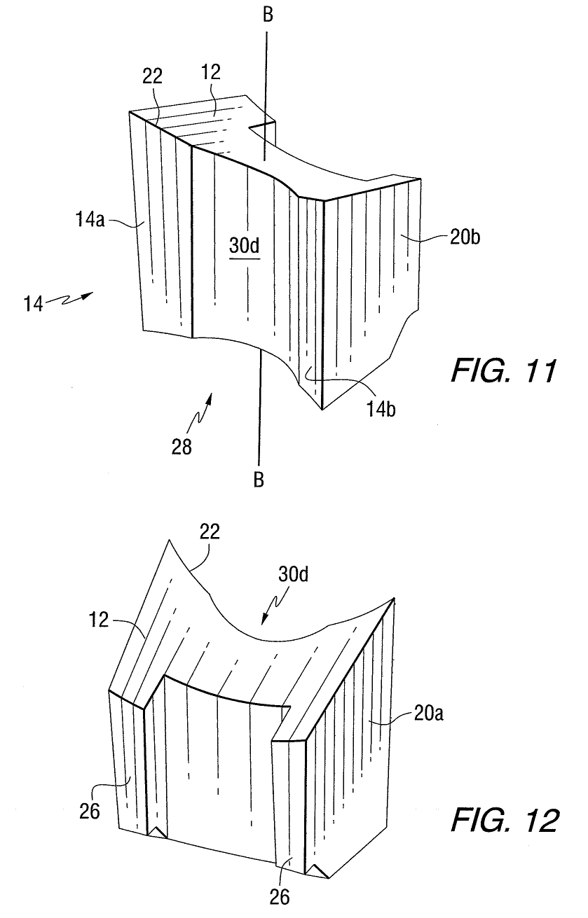

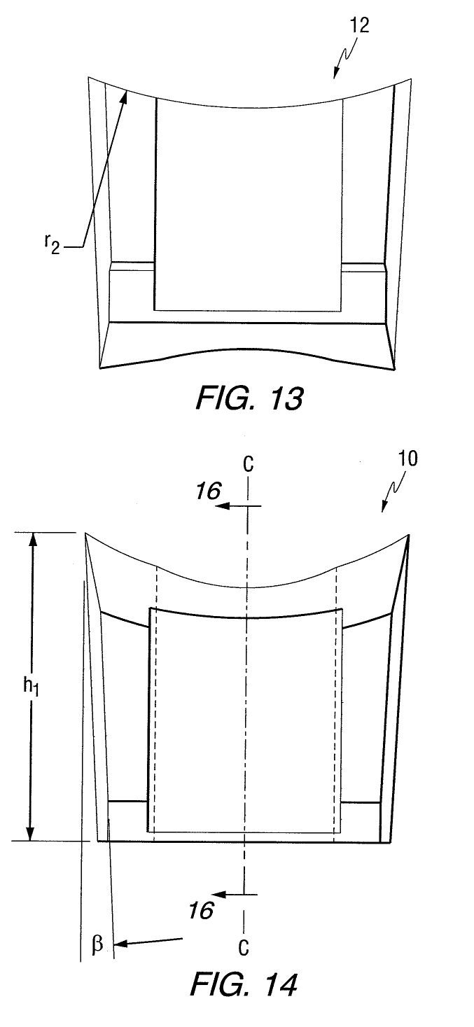

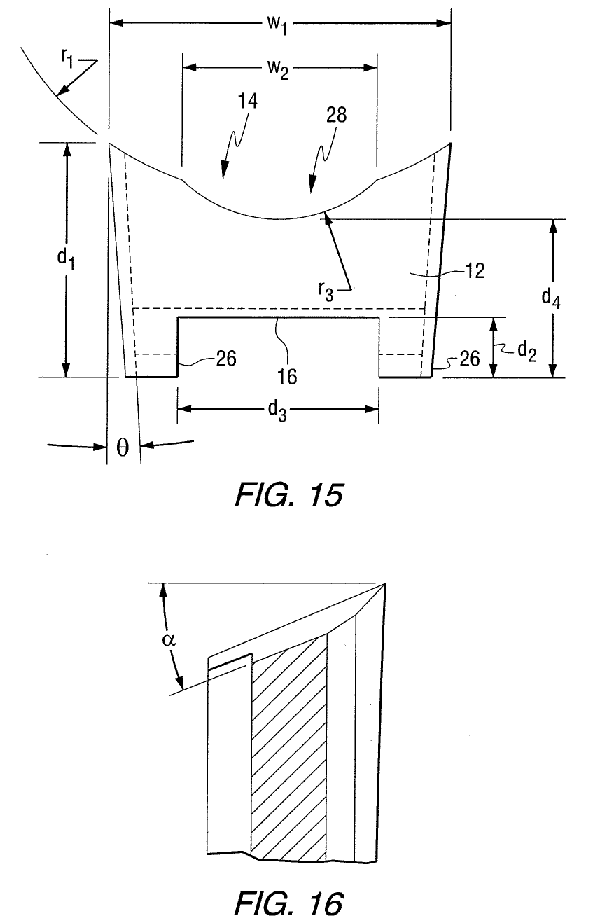

Front surface 14 is arcuately concave with a first radius r₁ of one inch, in the embodiments of FIGS. 2-7. Radius r₁ is smaller, as described below, in the embodiments of FIGS. 11-16. In the prior art, re-sharpening of face 14 is usually accomplished by hand using a diamond abrasive wheel 24. Wheel 24 may have various diameters. For example, to form a radius r₂ of one inch, wheel 24 is two inches in diameter. Difficulty has been experienced when field sharpening prior art teeth such as seen in FIG. 1 since the amount of pressure required to be applied by hand for effective sharpening is difficult to achieve because of the large contact area on the front surface.

To overcome this difficulty, in the present invention front surface 14 is formed with a medial notch, channel, gulley or groove 28 (collectively referred to as a groove) formed intermediate side surfaces 20 and 20a. In the embodiment of FIGS. 2-6 groove 28 has parallel sides 30a and 30b and a flat back surface 30c which is recessed behind the curvature of the surface of front surface 14. The intersection of sides 30a and 30b with back surface 30c of groove 28 define smoothly radiused corners 32, which reduce shear stress at the intersection and inhibit breakage of the tooth. Groove 28 separates front surface 14 into surfaces 14a and 14b and creates cutting surfaces 22a and 22b. Groove 28 further allows greater sawdust flow during rotation of the sawblade in direction A so as to saw workpiece 34 as sawdust is channelled through groove 28. The intersection of sides 20 and 20a of tooth 10 with front surfaces 14a and 14b creates side cutting edges 26a and 26b.

An alternative form of groove 28 is illustrated in FIG. 7 wherein the back surface 30c of groove 28 is arcuately concave and is radiused where it intersects sides 30a and 30b.

As may be viewed in FIGS. 8 through 10 replaceable cutter tooth 10 may be mounted directly onto a saw or indirectly through the use of a tooth holder or shank 40 as illustrated. Tooth 10 has the rear surface 16 and bottom surface 18 suitably shaped so as to afford a close toleranced fit with tooth holder or shank 40 for subsequent braising thereto.

Holder 40 is designed for removable mounting on to a saw in a radial aspect in a manner well noted in the prior art so that cutter tooth 10 projects radially outwardly of saw 42. Such mounting on a saw ensures that front surface 14 and groove 28 are also positioned in a radial aspect so as to project edge 22 radially outwardly relative to the saw 42.

In the further alternative embodiment of FIGS. 11-16, tooth 10 is modified from the embodiments of FIGS. 2-7 so as to include on front face 14 a groove 28 having a smoothly concave surface, concave about radial line B when mounted on tooth holder 40, and tooth holder 40 mounted on saw 42. Thus instead of groove 28 having parallel sides 30a and 30b and a back surface 30c extending between the parallel sides, groove 28 smoothly curves as a single continuous concave surface 30d from and between surfaces 14a and 14b of front face 14. Again, top cutting edge 22 extends along the intersection between front face 14, including surfaces 14a and 14b, and concave surface 30d, and top surface 12.

In this alternative embodiment, radius r₁, that is the radius forming the concavity of front face 14, may be approximately 0.45 inches, radius r₂, being the radius of the concavity of top surface 12 may be approximately 0.69 inches, and radius r₃ being the radius of the vertically extending concavity of groove 28 may be approximately 0.20 inches. As used herein, radius r₂ is also referred to as the second radius and radius r₃ is alternatively referred to as the third radius. By way of example, in this alternative embodiment, the height h₁ of tooth 10 may be approximately 0.51 inches measured parallel to the plane of symmetry C of tooth 10.

In the embodiment of FIGS. 11-16 tooth 10 has a front face width w₁ which may be approximately 0.50 inches, or, in an alternative embodiment, may be approximately 0.47 inches, and groove 28 may have a width w₂ of approximately 0.27 inches. Tooth 10 may have a depth d₁ from the leading edge of the side surface of the tooth to a rear-most edge of rear mounting flanges 26 extending rearwardly from rear surface 16 of approximately 0.33 inches. The rear flanges 26 may extend rearwardly a distance d₂ by approximately 0.08 inches and may be spaced apart distance d₃ of approximately 0.29 inches. The distance d₄ between the deepest recess of groove 28, which falls on plane of symmetry C, and the rear-most edge of rear mounting flanges 26 may be approximately 0.22 inches. Angle α may be approximately twenty degrees, angle β may be approximately 2.45 degrees and angle θ may be approximately 3.5 degrees.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A replaceable cutter tooth for mounting to a saw blade wherein the tooth comprises:
a substantially concave front cutting surface extending from and between opposite kerf forming side edges, and from a radially inner curved edge, radially inner when mounted on the saw blade, to a radially outermost curved cutting edge,
a groove extending in a radial direction, relative to the saw blade when said tooth is mounted thereon, from said radially inner curved edge to said radially outermost curved cutting edge, generally medially between and substantially parallel to said side edges so as to reduce the surface area of a front face of said front cutting surface, wherein said groove is recessed behind said front face relative to a direction of travel of said tooth and is an open groove when on said saw blade and said saw blade sawing a workpiece, whereby said surface area is reduced for ease of re-sharpening of said tooth and whereby said groove is not used for mounting a further cutting implement in it so as to occlude said groove during said sawing,
wherein said tooth has a concave top surface, said front cutting surface, a rear surface, a bottom surface and opposite side surfaces, and wherein said radially outermost curved cutting edge is a top cutting edge formed at an intersection of said concave top surface and said front cutting surface and wherein when viewed in side profile, said intersection of said top surface and said front cutting surface forms an acute angle.

2. The tooth of claim 1 wherein said groove has a first smoothly concave surface concave about said radial direction.

3. The tooth of claim 2 wherein said groove extends substantially the entire height of said front cutting surface.

4. The tooth of claim 3 wherein said groove is formed only of said first smoothly concave surface.

5. The tooth of claim 4 wherein a first cross section across said first smoothly concave surface, wherein said first cross section is substantially orthogonal to said radial direction, forms a first segment of a circle.

6. The tooth of claim 5 wherein said first segment of a circle has a corresponding first radius which is substantially constant for all said first cross sections along said groove.

7. The tooth of claim 6 wherein said first radius is substantially 0.2 inches.

8. The tooth of claim 1 wherein said acute angle between said concave top surface and said front surface is substantially seventy degrees.

9. The tooth of claim 1 wherein said side surfaces converge toward said bottom surface by a convergence angle.

10. The tooth of claim 9 wherein said convergence angle is substantially between two and three degrees on each side of said side surfaces.

11. The tooth of claim 1 wherein said concave top surface has a second smoothly concave surface.

12. The tooth of claim 11 wherein a second cross section across said second smoothly concave surface, wherein said second cross section is substantially parallel to said radial direction and substantially parallel to said front cutting surface, forms a second segment of a circle.

13. The tooth of claim 12 wherein said top cutting edge is formed of said second segment of a circle.

14. The tooth of claim 13 wherein said second segment of a circle at said top cutting edge has a second radius of substantially two thirds of an inch.

15. The tooth of claim 12 wherein said second segment of a circle has a corresponding second radius which is substantially constant for all said second cross sections across said concave top surface.

16. The tooth of claim 15 wherein said second radius is substantially two thirds of an inch.

17. The tooth of claim 14 wherein said acute angle is substantially seventy degrees.

18. The tooth of claim 14 wherein said top cutting edge has a width of substantially one half of an inch.

19. The tooth of claim 18 wherein said front cutting surface has a height of substantially one half of an inch.

20. The tooth of claim 1 wherein said groove includes an oppositely disposed, laterally spaced apart pair of side groove surfaces defining a rear groove surface therebetween recessed behind said front face, and wherein said front face includes a pair of laterally spaced apart faces on either side of said groove and elongate in said radial direction.

21. The tooth of claim 20 wherein said side groove surfaces and said rear groove surface define a channel.

22. The tooth of claim 20 wherein said rear groove surface is planar.

23. The tooth of claim 20 wherein said rear groove surface is concave.
